(19) United States
(12) Patent Application Publication
(10) Pub. No.: US 2009/0005001 A1
(43) Pub. Date: Jan. 1, 2009

(54) System and method for a wireless handset upgrade credit

(75) Inventor: Jeffrey M. Sweeney, Olathe, KS (US)

Correspondence Address: PATTON BOGGS, LLP, 2001 ROSS AVENUE, SUITE 3000, DALLAS, TX, 75201, US

(73) Assignee: Embarq Holdings Company, LLC

(21) Appl. No.: 11/823,529

(22) Filed: Jun. 28, 2007

(51) Int. Cl. H04M 1/66

(52) U.S. Cl. 455/406

(57) ABSTRACT

A system and method for a feature credit. A feature credit is determined for a user in response to services being utilized by the user. A feature credit balance is adjusted in response to determining the feature credit.

### BACKGROUND

The use of and development of wireless communications has grown nearly exponentially in recent years. The growth is fueled by larger wireless networks with more reliable protocols and better communications hardware available to service providers and consumers. Based on these drastic improvements, users have come to expect upgrades, enhanced features and services, and more advanced wireless devices that were unavailable only a few years earlier. In many cases, users are enticed to sign up for a wireless service plan or extended service agreement based on offers of free wireless devices or rebates. For example, in order to receive a rebate for the up front cost of a smart phone, the user may be required to sign a service contract for two years. Based on the costs associated with an extended term contract, users may expect their wireless service provider to offer a new wireless device near the end of their service contract strictly as a method of maintaining them as a customer.

Many times users feel that they are offered a new device or rebates strictly to persuade them to maintain or renew their current service contract. In some instances, users look for different wireless services providers offering better wireless devices out of resentment or frustration. Even high-priority customers that purchase costly wireless services or large scale service contracts and multiple wireless devices may experience such frustration. For example, a small business that purchases wireless service for fifty phones and messaging devices may be treated just like a casual wireless user. The result is that many wireless customers “chum” or continuously change wireless service providers in order to qualify for the best wireless devices for use with the purchased wireless service plan. In many cases, wireless service providers lose high-value customers as they move on to the newest and best wireless devices offered by a different wireless service provider. As a result, retaining wireless users to remain with a wireless service provider and supplying services and programs that are customer-focused has become increasingly important.

### SUMMARY

To provide an improved method of retaining wireless customers, a system and method for a feature credit. In one embodiment, a feature credit is determined for a user in response to services being utilized by the user. A feature credit balance is adjusted in response to determining the feature credit.

Another embodiment includes a billing system. The billing system may include a server configured to determine a handset upgrade credit issued to a user in response to an elapsed period of service. The billing system may also include a database in communication with the server, the database configured to store the handset upgrade credit for access by the server.

Yet another embodiment includes a billing system. The billing system may include a processor for executing a set of instructions. The billing system may further include a memory configured to store the set of instructions, wherein the set of instructions determines a new handset upgrade credit to issue to a user in response to an elapsed period of service, sums the new handset upgrade credit with a balance of a pre-existing handset upgrade credit to generate a total, and displays the new handset upgrade credit and the total to the user.

### BRIEF DESCRIPTION OF THE DRAWINGS

Illustrative embodiments of the present invention are described in detail below with reference to the attached drawing figures, which are incorporated by reference herein and wherein:

FIG. 1 is a pictorial representation of one embodiment of a wireless billing environment in accordance with an illustrative embodiment;

FIG. 2 is a block diagram of a billing system in accordance with an illustrative embodiment;

FIG. 3 is a flowchart of a process for accruing a handset upgrade credit in accordance with an illustrative embodiment;

FIG. 4 is a flowchart of a process for redeeming a handset upgrade credit in accordance with an illustrative embodiment; and

FIG. 5 is a graphical user interface for handset upgrade credits in accordance with an illustrative embodiment.

### DETAILED DESCRIPTION OF THE DRAWINGS

Illustrative embodiments of the present invention provide a system and method for a wireless handset upgrade credit. In one embodiment, a user accrues a monthly credit that may be used to acquire new wireless devices. The wireless handset upgrade credit may be based on the value of the user. The user value may be calculated based on the amount and types of services purchased by the user. The wireless handset upgrade credit is displayed to the user in a monthly bill, invoice, or electronically via a website or email.

As a result, the user may determine at any time how the credit has increased and view the current total credit. The wireless service provider may also give bonus credits based on upgrades or at strategic times in order to reward and motivate the user to maintain the wireless service. The wireless handset upgrade credit may increase customer retention and provide an incentive to retain and expand wireless services offered by a wireless service provider.

In one embodiment, the handset upgrade credit is one example of a feature credit. The feature credit, which may encompass the wireless handset upgrade credit, may be redeemed to purchase, wireless devices and accessories, ring tones, music, movies, streamable content, new features and services, receive discounts, and rebates. The feature credit may be determined, accrued, summed, traced, and otherwise reported by the systems and methods herein described.

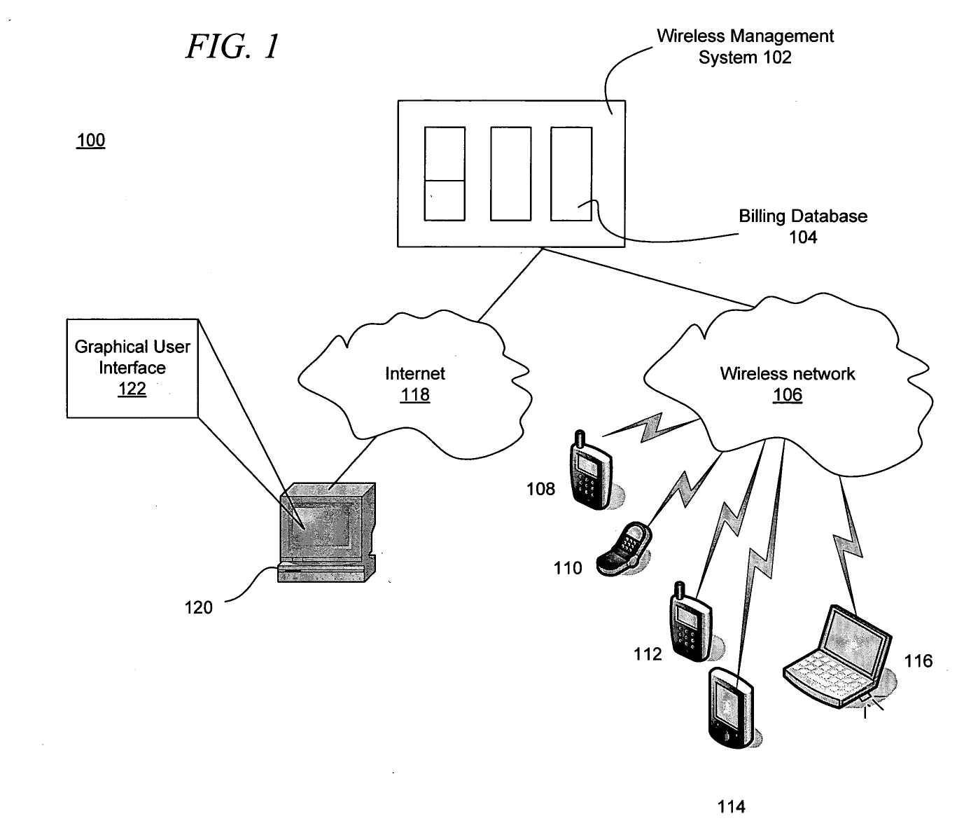

FIG. 1 is a pictorial representation of one embodiment of a wireless billing environment in accordance with an illustrative embodiment. The wireless billing environment 100 of FIG. 1 may include various components including a wireless management system 102, a billing database 104, a wireless network 106, wireless devices 108, 110, 112, 114, and 116, Internet 118, a client 120, and a graphical user interface (GUI) 122.

The wireless management system 102 may be a combination of hardware and software for managing the wireless network 106. The wireless management system 102 may be or include any number of intelligent network devices, servers, and components. For example, the wireless management system 102 may be an advanced intelligent network device that may quickly and economically modify the billing configuration and preferences of the billing database 104. The wireless management system 102 and the wireless network 106 may include any number of devices including mobile switching centers (MSC), exchanges, databases, home locator records, virtual locator records, wireless transceivers, servers, switches, routers, and other similar devices, connections, and components.

The billing database 104 may be used to track record, upgrade, and display a wireless handset upgrade credit to a user. In one embodiment, the client 120 may review and update information and preferences stored in the billing database 104. The wireless handset upgrade credit, handset upgrade credit, or upgrade credit as used herein is a credit given per specified time period that may be used or redeemed to purchase a selected wireless device. For example, the handset upgrade credit may be allotted to a user each month and redeemed to buy a telephone enabled for WiFi communication as well as cellular service. Alternatively, the handset upgrade credit may be used to upgrade services or other features. For example, the handset upgrade credit may be used to purchase unlimited text messaging for the year.

In one embodiment, the billing database 104 or wireless management system 102 may include a transactional module or transactional services for redeeming the handset upgrade credit to purchase a wireless device or wireless services. The transactional server may be used to process a payment from the user if the handset upgrade credit is insufficient to cover the cost of a wireless device, but the user wants to purchase the wireless device anyway. For example, the transactional server may be able to bill a user's credit card or wireless service account for an upgrade to a specified wireless device.

The billing database 104 may control invoicing, billing, payment and record keeping of services provided through the wireless network 106. In one embodiment, the billing database 104 may be an integrated software module within the wireless management system 102. In another embodiment, the billing database 104 may be a storage database or server linked with the wireless management system 102. Alternatively, the billing database 104 may be externally linked with the wireless management system 102.

The wireless management system 102 may perform administrative and automatic changes and configurations for the wireless network 106 by acting as a gateway, proxy, interface or control system. The wireless network 106 broadcasts wireless signals to the wireless devices 108, 110, 112, 114, and 116. The wireless devices 108, 110, 112, 114, and 116 may be any number of wireless devices including cellular phones, a Blackberry®, personal digital assistants (PDA), laptops, evolution data optimized (EDO) or broadband data cards, and other wireless communications or computing devices.

The wireless network 106 may use any number of wireless communication protocols including, but not limited to, code division multiple access (CDMA), time division multiple access (TDMA), global system for mobile (GSM) communications, WiFi, and WiMAX. The wireless management system 102 may communicate signals, data, and information with other wireless networks, publicly switched networks, data networks, such as the Internet 118, and other public and private communications networks.

The Internet 118 may be any type of data network connecting the wireless management system 102 and the client 120 using a fiber optic connection, T1, cable, DSL, satellite, high-speed trunk or other wired or wireless connection. Aspects of different embodiments may be performed by the wireless management system 102 and particularly the billing database 104 based on user feedback and communications with other data and/or communications systems.

Any number of communications protocols may be used to exchange data between the client 120 and the wireless management system 102. In one embodiment, the communications protocol is a common channel signaling system 7 (SS7). SS7 refers to the exchange of information between communications components required to provide and maintain service. The SS7 protocol is used by broadband networks to establish connections between switches and other devices in order to perform call-establishment, billing, routing, and information-exchange functions of the wireless network 106. The communications protocol may also be based on transmission control protocol (TCP) and Internet protocol (IP) standards or other commonly used communications protocols.

The client 120 may be a computing device suitable for displaying the GUI 122 to the user. For example, the client 120 may be a personal computer and the GUI 122 may be integrated or accessible from an application, such as a web browser. In another embodiment, the GUI 122 may be a secure client executed by a data processing system to perform the features and tasks described herein. Alternatively, the GUI 122 may be part of a website provided by the wireless management system 102 to allow the user to set handset upgrade credit preferences, perform transactions, and view handset upgrade credit activity.

The wireless management system 102 may include a host application for managing communication with one or more remote clients. A user may be required to provide a secure identifier, such as a user name, password, or other authentication code or hardware interface that verifies the user is authorized to make changes within the billing database before the client 120 is granted access to all or a portion of the billing database 104. The authentication information may be used to establish a secure connection between the client 120 and the wireless management system 102. The secure connection may be a virtual private network tunnel, an encrypted connection, firewall, or other form of secured communications link.

The GUI 122 may be configured to both display and receive information from the user. The user may include any number of fields, buttons, icons, and other interfacing elements for display content and receiving user input and selections. In particular, the GUI 122 may display the transaction history of the handset upgrade credits to the user's account. The GUI 122 may allow the user to view available wireless devices and the credits required to purchase a specified device. For example, if the price or cost of the wireless device in credit exceeds the users available handset upgrade credit total, the user may be shown an amount to purchase the device immediately, the amount of credits the user lacks, and how long it may take the user to acquire the amount of points required to purchase the specified wireless device.

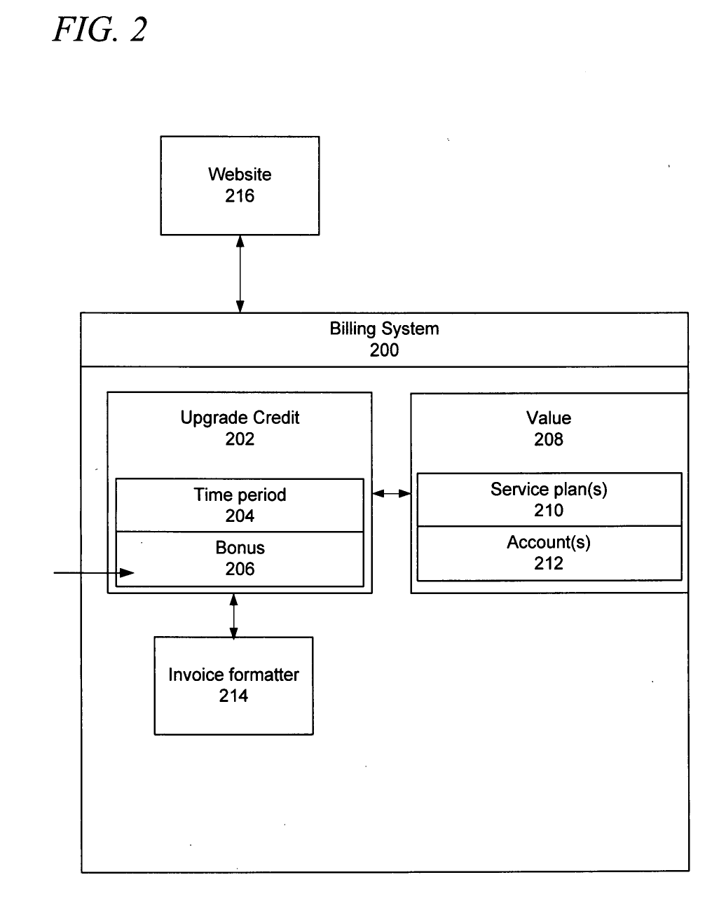

FIG. 2 is a block diagram of a billing system in accordance with an illustrative embodiment. The billing system 200 may include various hardware or software elements. In one embodiment, the billing system includes software modules including an upgrade credit, a time period 204, a bonus, a value, a service plan 210, an account 212, and an invoice formatter 214. The billing system 200 is a particular implementation of the billing database of FIG. 1.

FIG. 2 further includes a website 216. The website 216 is a particular implementation of the GUI 122 of FIG. 1. The website 216 may be used by customers/users and employees of the wireless service provider to enter and receive information from the billing system 200. The billing system 200 may stream data or website content that may be displayed to the user in a display program, such as a web browser.

The billing system 200 may include a processor or processing element and memory for executing programs, modules, or instructions as shown in the block format of FIG. 2. The upgrade credit 202 tracks and adds the handset upgrade credit based on the time period 204 and bonus 206. The time period 204 used for incrementing the handset upgrade credit may be specified by a policy or rule of the wireless service provider. For example, the time period may be daily, weekly, bi-weekly, monthly, or bi-monthly based on invoicing parameters used by the wireless service provider, or based on preferences established by the user. The wireless service provider may set an individualized handset upgrade credit that is incremented or tracked for each time period 204.

The bonus 206 may be a bonus or retention credit that is added to the running handset upgrade credit based on manual input or specified criteria. The bonus 206 may add a credit at times that have been statistically linked to customers seeking out other wireless service providers or otherwise cancelling or reducing services. The bonus 206 may also be linked to competitive pressures from other wireless service providers. For example, if another wireless service provider generates an offer or promotion that may potentially entice users to switch services, the bonus 206 may be generated to further persuade the users to remain with the wireless service provider.

Alternatively, the bonus 206 may receive manual input from a customer service representative or other employee of the wireless service provider. For example, based on a conversation in which the user expressed frustration with some aspect of the wireless service, a customer service representative may be authorized to provide a retention credit that is added to the bonus 206. In one embodiment, the bonus 206 may be programmed to generate a seasonal or date specific bonus credit. The bonus 206 may generate seasonal credits for holidays, birthdays, or other events. For example, the bonus 206 may generate a credit for the yearly anniversary date the user first signed up to be a customer with the wireless service provider. In another example, the bonus may generate a theme based credit for Christmas, Halloween, the Fourth of July or other cultural, social, and religious holidays celebrated by customers. Alternatively, the bonus 206 may generate credits for time periods during which the user may buy other users wireless devices or additional service plans as presents or gifts.

The addition of the bonus credits may be accompanied by an e-mail, paper, or text message thanking the user for being a valued customer and informing the user of the bonus credit. The message may also specify wireless devices that the user qualifies to purchase or may soon qualify to purchase with the handset upgrade credit. In on embodiment, the redemption of the handset upgrade credit may be linked with a user extending a service contract or signing a new service contract in order to ensure that the user will remain with the wireless service provider after using the handset upgrade credit.

The value 208 may determine if the handset upgrade credit based on an intrinsic value of the user. Most wireless service plans include policies and rules that all parties are receiving equal access to available services. The value may determine the handset upgrade credit based on the revenue provided to the wireless service provider. In one embodiment, the value 208 determinations may be made based on service plan 210 and account 212.

The service plan 210 may specify the services subscribed to by the user and the dollar value or profits generated from those services. For example, a user that pays for cellular, data, and text communications plans may be given a higher handset upgrade credit per month than a user that subscribes only to cellular service. The service plan 210 may include services provided by a communications service provider that are not wireless services, such as cable, wired Internet, satellite, DSL or other similar services. For example, a user that purchases a bundle of services at a higher cost may receive an increased handset upgrade credit.

The account 212 may specify how many different accounts the user has or may supervise. In one example, the user may have both business and personal accounts. As a result, the user may be given an increased handset upgrade credit over a different user that only subscribes to a paging service. In another example, the user may be a president, supervisor, chief technology officer, secretary, or other individual that manages or supervises a number of accounts. As a result, the supervising user may be given a large handset upgrade credit. This may provide the user with more incentive to retain all of the service plans 210 and accounts 212. Additionally, the user may use the greater apportionment of handset upgrade credits to purchase and test new wireless devices and services for potential roll-out to the other accounts managed by the user.

The upgrade credit 202 and value 208 software modules may also use other factors, parameters, rules, and administrative input to generate the handset upgrade credit and the bonus 206. For example, if the user has consistently paid on time, the upgrade credit 202 may increase the monthly handset upgrade credit. In another example, the user may be allotted additional handset upgrade credits for recommending other users to sign up for services offered by the wireless service provider.

In one embodiment, a base credit for each year or service term may be specified for each user. The base credit may be pro rated over the time period 204 and allotted by the upgrade credit as determined by the pro-rated value. The base credit may be further incremented based on the value 208, service plan 210, and account 212. The term of the wireless contract may also be set to vary based on the type of wireless device that the user may want to purchase with the handset upgrade credit.

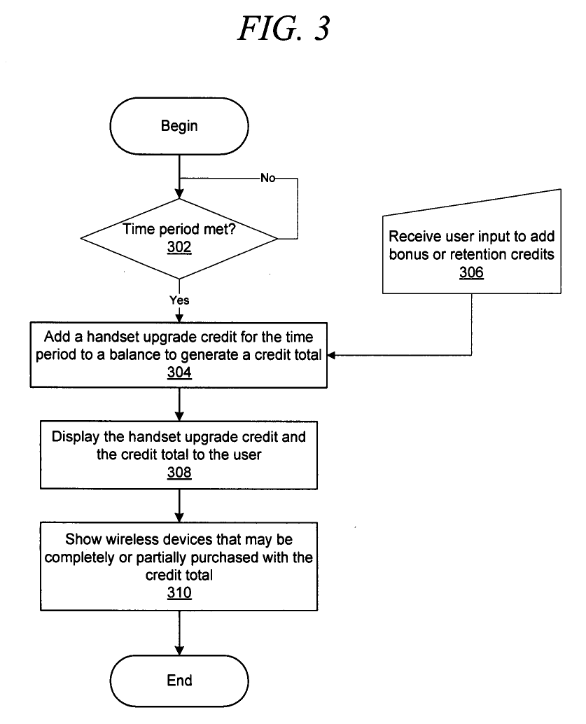

FIG. 3 is a flowchart of a process for accruing a handset upgrade credit in accordance with an illustrative embodiment. The process of FIG. 3 may be implemented by a billing system, billing modules of a MSC, or other wireless management control system. The process may begin by determining whether a time period is met (step 302). The time period may be the regular billing or invoice period for a wireless service provider. In one embodiment, the time period is a month. The beginning and ending of the time period may be established for all users or may depend on when the user initially signed up for wireless service. The time period may also be a day, week, bi-weekly period, bimonthly period, year or any time frame suitable for billing a wireless user or providing billing and usage information.

Next, the billing system adds a handset upgrade credit for the time period to a balance to generate a credit total (step 304). The handset upgrade credit may be the credit apportioned for each specified time period. The handset upgrade credit may have been set or determined at the time the user signed a service contract. The handset upgrade credit may also be determined based on a value or level assigned to the user. For example, the value levels may include low, medium, and high value users for determining the handset upgrade credit apportioned each month. The valve may be specified based on factors which may include revenue generated for the wireless service provider by the user, service plan(s), and account(s) as previously described. The handset upgrade credit allotted to the user may vary each month or based on any number of factors as herein described. The balance may be the running total or summed total of the previously accrued handset upgrade credits. The total may be calculated by adding the previous balance with the handset upgrade credit for the month or other specified time period.

At anytime, the billing system may receive user input to add bonus or retention credits (step 306). The bonus or retention credits may be added to the handset upgrade credit or directly to the balance. The bonus or retention credits may be manually submitted or generated barred on pre-defined criteria. The pre-defined criteria may be information or statistics regarding the likelihood of losing the user as a customer. For example, a wireless service provider may be statistically more likely to lose customers at eighteen months into a two year contract. As a result, the billing system may generate or receive user input to add fifty credits as a bonus at the seventeen month mark. The billing system adds a handset upgrade credit for the time period to a balance to generate a credit total (step 304). As mentioned in step 306, the handset upgrade credit may include the bonus or retention credits.

Next, the billing system displays the handset upgrade credit and the credit total to the user (step 308). The credit information of step 308 may be displayed in any number of ways. In one embodiment, the credit information may be displayed in a monthly billing invoice mailed to the user. Alternatively, the invoice may be saved in electronic format and e-mailed to the user. In yet another embodiment, the user may view the credit information of step 308 using a graphical user interface of a website or other electronic interface. For example, the website may be displayed to the user's personal computer by a server of the billing system.

The billing system may also show wireless devices that may be completely or partially purchased with the credit total with the process terminating thereafter (step 310). In one example, the credit total may have incremented to the point that the user may redeem the credits completely to obtain a specified wireless device. Alternatively, the total credits may be insufficient to obtain a specified wireless device. As a result in step 310, the user may be shown a purchase price that may be paid in conjunction with the redemption of the total credits to purchase the specified device. For example, if a newly released smart phone/PC is available for 400 credits but the user only has 280 credits, the user may still be able to use the smart phone/PC if willing to pay the dollar equivalent of 120 credits which may be $60.

In step 310, the user may also be shown the cost in credits and how long the user may need to wait before he/she has accrued the amount of credits necessary to purchase selected wireless devices. The handset upgrade credit of FIG. 3 may motivate wireless users to retain wireless service through a service provider based on the future redemption of credits and availability of credit information.

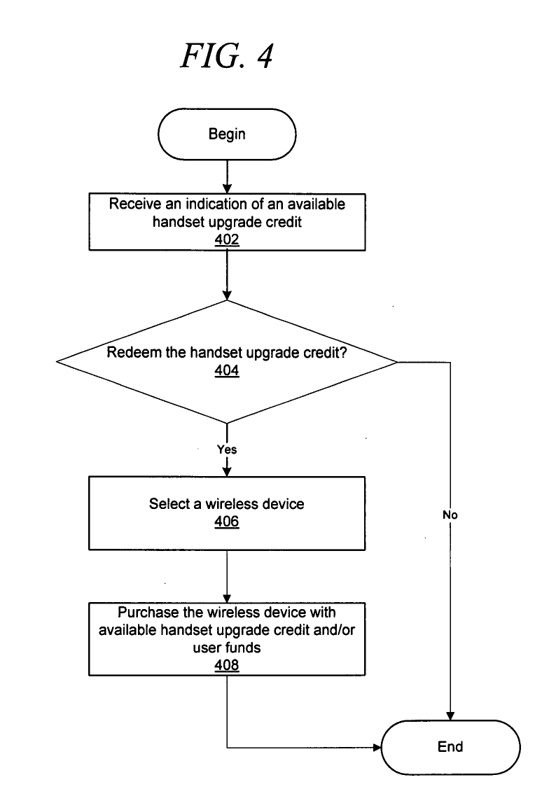

FIG. 4 is a flowchart of a process for redeeming a handset upgrade credit in accordance with an illustrative embodiment. The process of FIG. 4 may be implemented by a user using a computing device such as a personal computer, PDA, wireless phone, or other similar system or device. A website, graphical user interface, or other electronic interface may be used to display information and receive user input. The process begins with the user receiving an indication of an available handset upgrade credit (step 402). The indication may be received in a paper invoice, email, text message, or through a graphical user interface as previously described.

The available handset upgrade credit may be a credit total as increased per specified time period. Next, the user determines whether to redeem the handset upgrade credits (step 404). The user may make the decision based on factors, such as available wireless devices, credit cost of a specified wireless device, available upgrade credit, service plan, or other information.

If the user determines not to redeem the handset upgrade credit, the process terminates. If the user determines to redeem the handset upgrade credits in step 404, the user selects a wireless device (step 406). The user may select the device from a list of categories of wireless devices. In one example, the user may select the device in step 406 from a website of the wireless service provider. In order for the device to be purchased, the device may require authorization by the wireless service provider as a device compatible with the services, structures, and protocols of the wireless network.

Next, the user purchases the wireless device with the available handset upgrade credit and/or user funds (step 408) with the process information thereafter. If the available handset upgrade credit is insufficient to purchase the wireless device, the user may be required to pay a portion of the cost of the wireless device. However, the option to mix credits and user funds may provide the user more flexibility and increased satisfaction with the wireless service provider.

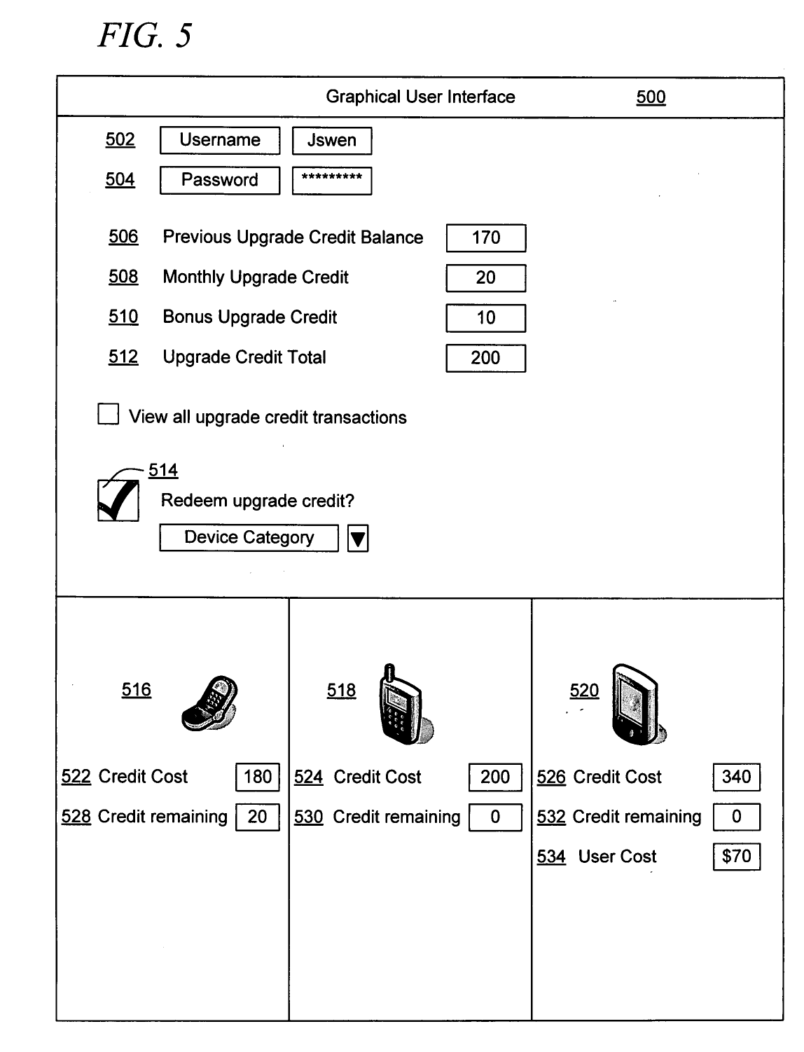

FIG. 5 is a graphical user interface for handset upgrade credits in accordance with an illustrative embodiment. The graphical user interface (GUI) 500 may be displayed to a user in any number of ways. In one embodiment, the GUI 500 may be viewed from a website of a wireless service provider as a webpage. In another embodiment, the GUI 500 may be displayed in an email or text message. Alternatively, a hard copy of the GUI 500 may be printed and mailed to the user as a bill, invoice, statement, or other account information.

The GUI 500 may display a variety of information to the user. In addition, the GUI 500 may include interactive components for receiving user input. The features shown in the GUI 500 are one illustrative example of details and features that may be displayed to the user and are shown only as an example. The GUI 500 may include a user name 502, password 504, previous upgrade credit balance 506, monthly upgrade credit 508, bonus upgrade credit 510, upgrade credit total 512, redeem upgrade credit indicator 514, wireless devices 516, 518, and 520, credit cost 522, 524, 526, credit remaining 528, 530, and 532, and user cost 534. The GUI 500 may be linked to multiple accounts and service features of the wireless service plan and may be one page of multiple account information pages that may be available to the user.

The user name 502 and password 504 may be used to ensure that the user is authorized to view the content of the GUI 500, make account changes, and provide user input. In one embodiment, the user name 502 and password 504 may be used to establish a secure connection between a client device of the user and the billing system. The secure connection may be a virtual private network tunnel, an encrypted connection, firewall or other form of secured communication link suitable for exchange data securely. The user name and password may be verified by an authentication device or module of the billing system.

The GUI 500 may display various wireless handset upgrade credit values or upgrade credits. In one embodiment, the GUI 500 displays a previous upgrade credit balance 506. The previous upgrade credit balance 506 may display the running balance for the accrued upgrade credits as of the previous billing statement or monthly invoice. The monthly upgrade credit 508 may show how many credits accrued for the specified time period. In this example, the time period is a month.

The bonus upgrade credit 510 may be a bonus credit given to the user. The bonus upgrade credit 510 may be a bonus or retention credit automatically or manually added to the user's account. In one example, a retention credit may be supplied as the bonus upgrade credit 510 in response to a customer service representative determining that the user may be experiencing some frustration with the current wireless service plan or wireless device in order to retain the user as a customer. The bonus upgrade credit 510 may also be provided for updating a wireless service plan, completing a survey, continuous on-time payments, or other factors. The bonus upgrade credit 510 may also be a seasonal credit that is allotted each year or at specific dates. For example, the user may receive an additional credit in December or January for Christmas, Hanukah, or New Years Eve. In one example, the wireless service provider may specify days or events for which the user receives additional bonus upgrade credits.

The upgrade credit total 512 may be the new total of the accumulated upgrade credits. As shown the upgrade credit total 520 is the sum of the previous upgrade credit balance 506, monthly upgrade credit 508, and the bonus upgrade credit 510 if any are included. The upgrade credit total 512 may be the credits available to the user for redemption.

In one embodiment, the GUI 500 may allow a user to sort, filter, or otherwise view all upgrade credit transactions for the previous upgrade credit balance 506, monthly upgrade credit 508, bonus upgrade credit 510, and upgrade credit total 520.

The GUI 500 may include the redeem upgrade credit indicator 514. The redeem upgrade credit indicator 514 may be a button, icon, toggle, or other graphical interface for receiving a selection or user input from a user. As previously mentioned, the user may subscribe to any number of wireless services which may include cellular service, paging, GMRS, WiFi, WiMax, or other wireless communication protocols that enable voice and data communications. As a result, once the redeem upgrade credit indicator is selected, a service or device category may be selected in order to enable the GUI 500 or a program, instructions, or logic controlling the GUI 500 to display an assortment of devices enabled for a specified service. In one example, the wireless devices 516, 518, and 520 may be available from the wireless service provider. The wireless devices 516, 518, and 520 may be displayed to the user in terms of cost in credits and/or dollars as illustrated by credit costs 522, 524, and 526.

The wireless devices 516, 518, and 520 may cost more than the upgrade credit total 512. As a result, the GUI 500 may display credits remaining 528, 530, and 532 for each wireless device 516, 518, and 520 as well as user cost 534 for displayed wireless devices for which the credit cost 526 exceeds the upgrade credit total 512. As shown, if the user selects to redeem the upgrade credit total to purchase the wireless device 520, the user cost 534 may be required because the credit cost 526 exceeds the upgrades credit total 512.

The information displayed by the GU 500 may encourage a user to remain with a wireless service provider by providing incentives and valuable information. In particular, the credit costs 522, 524, and 526, credits remaining 528, 530, and 532, and user cost 534 may allow a user to view and see how the upgrade credit total 512 is increasing an may be used.

The GUI 500 may include multiple types, screens, and pages of wireless devices, 516, 518, and 520. In one embodiment, the wireless devices 516, 518, and 520 may be linked with additional features, services, and plans. For example, if the user selects to redeem the upgrade credit total 512 to purchase the wireless device 518, the user may be required to upgrade to a special plan for text messaging or an increased bundle of anytime use calling minutes. As a result, the GUI 500 may be used to offer expanded services and features to users in order to retain users and expand revenue generation. In one embodiment, the GUI 500 may allow a user to sort, filter, or otherwise view all upgrade credit transactions for the previous upgrade credit balance 506, monthly upgrade credit 508, bonus upgrade credit 510, and upgrade credit total.

The GUI 500 may include a redeem upgrade credit indicator 514. The redeem upgrade credit indicator 514 may be a button, icon, toggle, or other graphical interface for receiving a selection or user input from a user. The user may subscribe to any number of wireless services which may include cellular service, paging, GMRS, WiFi, WiMax, or other wireless communication protocols that enable voice and data communications. As a result, once the redeem upgrade credit indicator is selected, a service or device category may be selected in order to enable the GUI 500 or a program, instructions, or logic controlling the GUI 500 to display an assortment of devices enabled for a specified service. In one example, the wireless devices 516, 518, and 520 may be available from the wireless service provider. The wireless devices 516, 518, and 520 may be displayed to the user in terms of cost in credits and/or dollars as illustrated by credit costs 522, 524, and 526.

The wireless devices 516, 518, and 520 may cost more than the upgrade credit total 512. As a result, the GUI 500 may display credits remaining 528, 530, and 532 for each wireless device 516, 518, and 520 as well as user cost 534 for displayed wireless devices for which the credit cost 526 exceeds the upgrade credit total 512. As shown, if the user selects to redeem the upgrade credit total to purchase the wireless device 520, the user cost 534 may be required to purchase the wireless device 520.

The information displayed on the GUI 500 may motivate a user to remain with a wireless service provider by providing incentives and valuable information. In particular, the credit costs 522, 524, and 526, credits remaining 528, 530, and 532, and user cost 534 may be used.

The GUI 500 may include multiple types, screens, and pages of wireless devices 516, 518, and 520. In one embodiment, the wireless devices 516, 518, and 520 may be linked with additional features, services, and plans. For example, if the user selects to redeem the upgrade credit total 512 to purchase the wireless device 518, the user may be required to upgrade to a special plan for text messaging or an increased bundle of anytime use calling minutes. As a result, the GUI 500 may be used to offer expanded services and features to users, retain loyal customers, counteract competitive pressures and expand revenue generation.

The previous detailed description is of a small number of embodiments for implementing the invention and is not intended to be limiting in scope. The following claims set forth a number of the embodiments of the invention disclosed with greater particularity.

What is claimed:

1. A method for a feature credit, said method comprising:
determining a feature credit for a user in response to services being utilized by the user, and
adjusting a feature credit balance in response to the determining the feature credit.

2. The method according to claim 1, wherein the feature credit balance is adjusted periodically based on a time period.

3. The method according to claim 1, further comprising:
displaying the feature credit and the feature credit balance to the user, wherein the displaying occurs on a monthly billing statement.

4. The method according to claim 1, further comprising:
upgrading a handset based on a user selection to redeem the feature credit balance to purchase the handset.

5. The method according to claim 1, wherein the determining occurs based on a value of the user.

6. The method according to claim 5, wherein the value is determined based on revenue received from the user.

7. The method according to claim 1, wherein adjusting further comprises:
adding a bonus credit or a retention credit to the feature credit balance.

8. The method according to claim 7, wherein adding the bonus credit or the retention credit occurs in response to competitive pressure from another communications service provider.

9. The method according to claim 1, wherein determining further comprises:
pro-rating the feature credit based on a communications service agreement.

10. The method according to claim 1, wherein the feature credit may be redeemed for any of ring tones, wireless services, wireless features, wireless devices, rebates, and discounts.

11. The method according to claim 7, wherein the bonus credit or retention credit is added seasonally.

12. The method according to claim 5, wherein the value is determined by a level based on one or more wireless service plans and number of accounts.

13. The method according to claim 1, wherein the feature credit may be used to upgrade a wireless service plan or feature of the wireless service plan.

14. The method according to claim 1, further comprising:
pro-rating a service term handset upgrade credit for the time period to determine the handset upgrade credit.

14. A billing system, said system comprising:
a server configured to determine a handset upgrade credit issued to a user in response to an elapsed period of service; and
a database in communication with the server, the database configured to store the handset upgrade credit for access by the server.

15. The system according to claim 11, wherein the server includes modules for recording the handset upgrade credit, determining the value of a user, summing the handset upgrade credit, and receiving user input regarding a bonus credit or a retention credit.

16. The system according to claim 11, further comprising:
a purchasing system for redeeming the handset upgrade credit to any of purchase a wireless device, upgrade a wireless feature, upgrade a wireless service, receive a discount, and receive a rebate.

17. The system according to claim 11, wherein the server is configured to provide an interface to one or more clients to display the handset upgrade credit to the user through a network connection.

18. A billing system comprising:
a processor for executing a set of instructions;
a memory configured to store the set of instructions, wherein the set of instructions determines a new handset upgrade credit to issue to a user in response to an elapsed period of service, sums the new handset upgrade credit with a balance of a pre-existing handset upgrade credit to generate a total and displays the new handset upgrade credit and the total to the user.

19. The system according to claim 11, wherein the set of instructions are configured to perform a transaction to redeem the total to purchase a wireless device.

20. The system according to claim 11, wherein the set of instructions further determines a value of the user for determining the handset upgrade credit based on revenue received from the user.
